(19) United States
(12) Patent Application Publication
(10) Pub. No.: US 2007/0004344 A1
(43) Pub. Date: Jan. 4, 2007

(54) Wireless device and system for discriminating different operating environments

(76) Inventors: Robert J. DeGroot, Chicago, IL (US); Nicholas E. Buris, Deer Park, IL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/170,329

(22) Filed: Jun. 29, 2005

(51) Int. Cl. H04B 1/38; H04M 1/00; H04B 1/44; H04B 17/00

(52) U.S. Cl. 455/78; 455/73; 455/67.11

(57) ABSTRACT

Wireless communication systems (100, 800) comprise mobile units (118, 802) provided with a directional coupler (206) and circuit (220) for measuring the complex reflectance (phase and magnitude) of antenna (202) of the mobile units (118, 802). The system (100, 800) has, either in the mobile unit (118, 802) or elsewhere, a processor (238, 808) programmed to perform pattern recognition of the near field environments of the mobile units (118, 802) by using the complex reflectance measurements as feature vectors. Information as to the near field environment at the time of wireless connection drops is suitably accumulated and is used in network upgrade planning and/or mobile unit design evaluation. The complex reflectance is alternatively used to discriminate antenna faults. Alternatively, near field environments that tend to degrade wireless communication performance are detected by the mobile unit using the complex reflectance and the mobile unit then alerts the user.

### FIELD OF THE INVENTION

The present invention relates generally to mobile wireless communication systems and devices.

### BACKGROUND

The widespread adaptation of cellular wireless communications has revolutionized personal communications. Access to communication networks is no longer limited to locations served by wired telephone networks. Wireless cellular communication depends on carefully planned arrangements of base station transceivers through which mobile wireless communication devices (e.g., cellular telephones) are able to connect to signal conduit (e.g., optical fiber, copper) based voice and data networks. Maintaining good wireless communication between the mobile communication device (termed the ‘mobile unit’) and the base station transceivers depends on a number of factors including (1) the large-scale (far field) physical environment (e.g., the geometry of buildings and other structures) in the vicinity of base stations which affects the propagation of radio waves in the vicinity of the base stations (2) interference from other mobile units and other Radio Frequency Interference (RFI) sources, and (3) the near field environment of the mobile unit, which is controlled by a user's positioning and manner of holding the mobile unit. Each of the foregoing factors is itself complicated to analyze. The large-scale physical environment, especially in dense urban settings can produce complex nonuniform signal strength distributions by blocking, reflecting and diffracting radio waves. Interference from other mobile units or other RFI sources is dynamic and depends on the locations and power of the sources of interferences, which are not known. Additionally, a user may place or hold a mobile unit in a manner that leads to poor antenna performance. Any of the above-mentioned factors can result in loss of network connections (e.g., ‘call drops’)

In planning wireless infrastructure improvements such as densification of the infrastructure to support more users and/or higher bandwidth or upgrading to more advanced protocols (e.g., 3.5G, 4G), decisions must be made on how to allocate resources to obtain the best network coverage and avoid call drops. While it is possible to gather statistics on call drops there is some uncertainty as to the cause of the call drops. Network planning decisions and mobile unit design decisions would be better informed if call drops due to users' placement and manner of holding the mobile unit could be differentiated from call drops due to other causes. Moreover, it would improve Quality of Service (QoS) in wireless communication systems if users could be informed that their placement or manner of holding their mobile unit was degrading the QoS.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example of a wireless communication system in accordance with some of embodiments of the invention;

FIG. 2 is an example of a mobile unit in accordance with some embodiments of the invention;

FIG. 3 is a flowchart of a method of determining decision rules for classifying near field environments of a mobile unit in accordance with some embodiments of the invention;

FIG. 4 is a first Smith chart showing complex reflectance data for twelve near field environments of a particular model of mobile unit;

FIG. 5 is a flowchart of a method of collecting and transmitting data about near field environments of a mobile unit;

FIG. 6 is a flowchart of a method of detecting an incorrect type antenna or an antenna fault condition in a mobile unit;

FIG. 7 is a second Smith chart showing complex reflectance measured in a UHF two-way radio with a correct UHF antenna, with a broken UHF antenna and with an incorrect VHF antenna;

FIG. 8 is a block diagram of a wireless communication system in accordance with some embodiments of the invention;

FIG. 9 is a flowchart of a method of alerting a mobile unit user that the near field environment of the mobile unit is adversely affecting performance of the mobile unit;

FIG. 10 is a graph including plots of return loss vs. frequency for two near field environments of a mobile unit;

FIG. 11 is smith chart showing complex reflectance for a range of frequency for the two near field environments; and

FIG. 12 is a block diagram of a user interface of a cellular telephone type mobile unit.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to discriminating a near field environment of a mobile unit and antenna fault detection in a mobile unit. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of discriminating the near field environment of a mobile unit and antenna fault detection in a mobile unit described herein. The non-processor circuits may include, but are not limited to, a radio receiver, a radio transmitter, signal drivers, clock circuits, power source circuits, and user input devices. As such, these functions may be interpreted as steps of a method to perform discrimination of a near field environment of a mobile unit and detection of antenna faults in a mobile unit. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

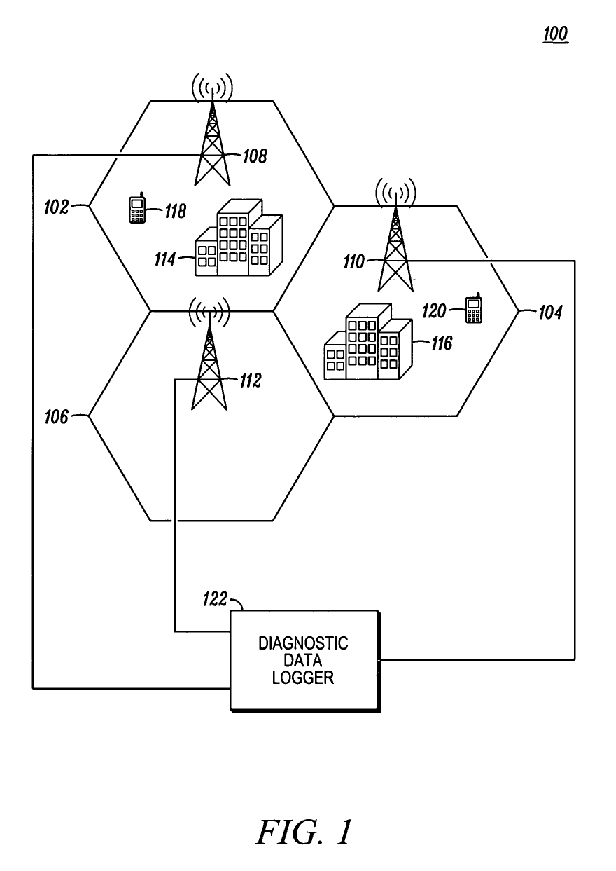

FIG. 1 is an example of a wireless communication system 100 in accordance with some embodiments of the invention. The system 100 comprises a plurality of cells including a first cell 102, a second cell 104, and a third cell 106, which are served, by a first base station 108, a second base station 110 and a third base station 112 respectively. Although only three cells are shown in FIG. 1, it will be appreciated by those of ordinary skill in the art that many more cells are provided. The cells 102, 106, 104 provide service to overlapping contiguous areas. A first building 114 is shown located in the first cell 102 and a second building 116 is shown located in the second cell 104. A first mobile unit 118 is located in the first cell 102 and a second mobile unit 120 is located in the second cell 104. It will be appreciated by those of ordinary skill in the art that there may be many buildings in each cell which scatter and block wireless signals resulting in a complicated nonuniform distribution of signal strength within the system 100. The complicated nonuniform distribution of signal strength makes it difficult to easily determine if wireless connection breaks are due to low signal strength or the near field environment of the mobile unit 118. Although only two mobile units 118, 120 are shown, it will be appreciated by those of ordinary skill in the art that many mobile units and other sources of RFI may be present in a geographic region served by the system 100. Uncertainties as to the strength and locations of RFI sources makes it difficult to determine if wireless connection breaks are due to RFI or the near field environment of the mobile unit 118. A diagnostic data logger 122 is communicatively coupled (e.g., through a Radio Area Network (RAN)) to the three base stations 108, 110, 112. The diagnostic data logger 122 logs data on the near field environments of the mobile units 118, 122 recorded by the mobile units 118, 122 and sent through the system 100.

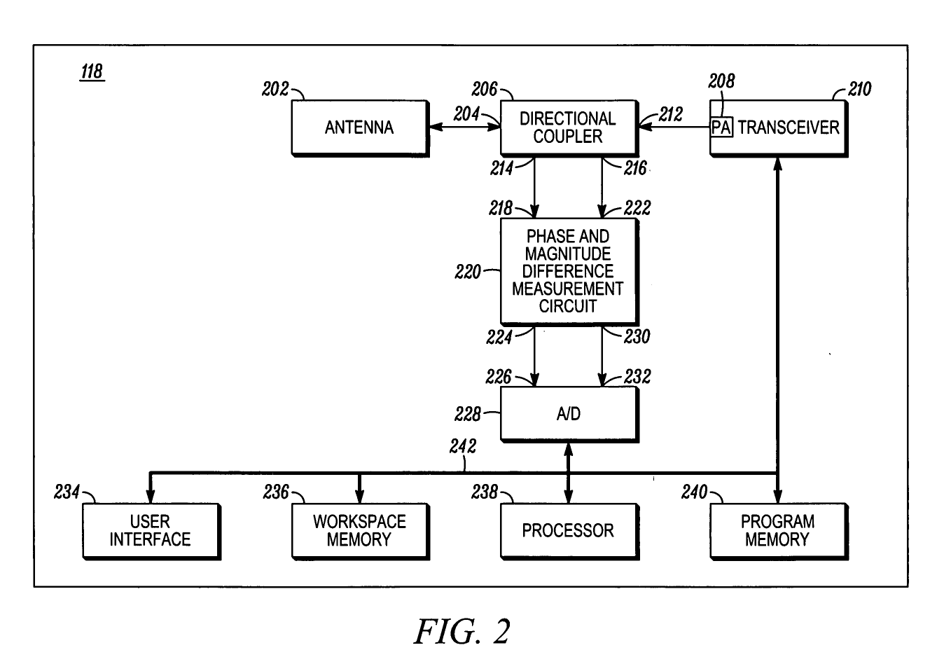

FIG. 2 is a block diagram of the first mobile unit 118 in accordance with some embodiments of the invention. It will be appreciated by those of ordinary skill in the art that the second mobile unit 120 can be of similar design or alternatively can be a different design. As shown in FIG. 2, the first mobile unit 118 comprises an antenna 202 that is coupled to an input/output port 204 of a directional coupler 206. A power amplifier 208 of a transceiver 210 is coupled to an input port 212 of the directional coupler 206. The directional coupler 206 couples a signal that is to be transmitted from the power amplifier 208 to the antenna 202. A portion of the signal reaching the antenna 202 is reflected back toward the power amplifier 208. A first measurement port 214 of the directional coupler 206 samples the signal going from the power amplifier 208 to the antenna 202. A second measurement port 216 samples the portion of the signal that is reflected back from the antenna 202.

The first measurement port 214 is coupled to a first signal input 218 of a phase and magnitude difference measurement circuit 220 and the second measurement port 216 is coupled to a second signal input 222 of the phase and magnitude difference measurement circuit 220. The phase and magnitude difference measurement circuit 220 measures the differences between the phases and magnitudes of the signal propagating from the power amplifier 208 toward the antenna 202 and the signal reflected back toward the power amplifier 208. The differences in phases and magnitudes can be expressed as a complex reflectance. One suitable phase and magnitude difference measurement circuit, for example, is the AD8302 manufactured by Analog Devices of Norwood, Mass.

A phase difference output 224 of the phase and magnitude difference measurement circuit 220 is coupled to a first input 226 of a two channel analog-to-digital converter (A/D) 228. A magnitude difference output 230 of the phase and magnitude difference measurement circuit 220 is coupled to a second input 232 of the A/D 228. The A/D 228 produces binary representations of the phase difference and magnitude difference.

The A/D 228, the transceiver 210, a user interface 234, a workspace memory 236, a processor 238, and a program memory 240 are coupled together through a signal bus 242.

The processor 238 is capable of reading the binary representations of the phase difference and magnitude difference from the A/D 228 through the signal bus 242. The binary representation of the phase difference and magnitude difference can be stored in the workspace memory 236 and periodically updated. The program memory 240 stores a pattern recognition program for classifying the near field environment of the first mobile unit 118 based on the phase difference and magnitude difference. The program memory 240 also stores data that defines decision regions and/or other classification rules that are used by the pattern recognition program to classify the near field environment of the first mobile unit 118 based on the phase difference and magnitude difference.

The user interface 234 suitably comprises outputs such as a speaker, tactile alert and/or display and inputs such as a microphone and/or keypad as is well known in the art. According to certain embodiments the outputs of the user interface 234 are used to alert the user if the user is holding the first mobile 118 unit or has positioned the first mobile unit 118 such that the near field environment of the first mobile unit tends to degrade the Quality of Service (QoS) that is obtained. Certain hand positions and certain objects being placed in proximity to the first mobile unit 118 have the potential to degrade the QoS by interfering with transmission or reception of signals by the antenna 202. For example, a user placing a finger or other part of his/her hand directly on the antenna 202, or placing the first mobile unit 118 on metal desk or other metal object tends to degrade QoS.

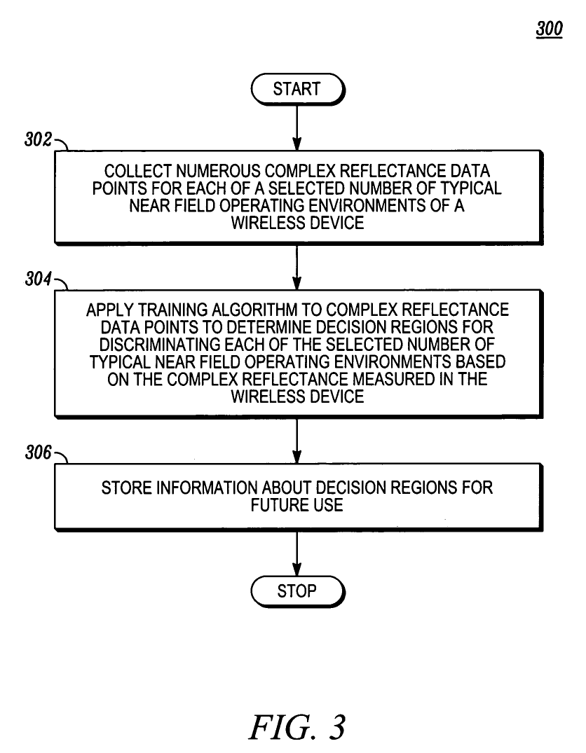

FIG. 3 is a flowchart of a method 300 of determining decision rules for classifying near field environments of a mobile unit in accordance with some embodiments of the invention. The method 300 is carried out for each model of mobile unit having a different antenna system. Each model of mobile unit with a different antenna design will produce different results (i.e. decision regions) when the method 300 is used. In block 302 training data is collected. The training data includes numerous phase and magnitude difference (complex reflectance) points for each type of near field environment that is to be recognized by the pattern recognition software used in the mobile unit (e.g., 118). For each near field environment that is specified as a person holding a mobile unit in a particular way (e.g., holding a cellular telephone type mobile unit at the side of the face for talking, or holding the mobile unit in one hand while dialing with the other hand), the training data includes data collected with a number of different people holding the mobile unit in that particular way. For each near field environment that is defined as the mobile unit located proximate to a particular object (e.g. placed on a nonconductive surface), the training data includes data collected with a number of different examples of the particular object (e.g., different nonconductive surfaces). The phase difference and magnitude difference are used as two elements of feature vectors used to classify the near field environments of the mobile unit. To account for manufacturing variances the training data suitably includes duplicative data collected using more than one (e.g., five or ten) mobile units of the same model. If, as in the case of cellular telephones, the mobile unit is capable of operating in a number of frequency channels within one or more frequency bands, then the data collected in block 302 is suitably collected in each frequency band.

In block 304 a pattern recognition training algorithm is applied to the training data collected in block 302 in order to determine information about decision regions corresponding to each type of near field environment of the mobile unit that is to be recognized. The pattern recognition training algorithm can be, by way of non limiting example, a training algorithm for Bayesian classification, linear classification, or nearest neighbor classification. Pattern recognition algorithms have previously been applied to a variety of different application including face recognition, voice recognition and hand writing recognition. For each application, a different method is used to extract feature vectors which characterize that which is to be recognized. Once the feature vectors are extracted the various classification methods such as those mentioned can be applied without regard to the method by which the feature vectors were extracted. In the present application, the complex reflectance's at one or more frequencies serve as feature vectors. The details of pattern recognition algorithms are widely known. For example, pattern recognition algorithms are described in Webb, A. R. Statistical Pattern Recognition, John Wiley and Sons, 2002 and Theodoridis S., Koutroumbas, K. Pattern Recognition, Elsevier 2003. In embodiments in which the near-field environment is discriminated based on complex reflectance at a single frequency, in as much as the complex reflectance is two dimensional, the decision surfaces that bound the decision regions are lines or curves in a two dimensional space of complex reflectance (e.g., a space of magnitude and phase or space of real and imaginary parts). In the case that the mobile unit is capable of operating in multiple frequency channels, block 304 is suitably applied to the data collected in each frequency channel separately. The decision region information obtained for each particular frequency channel would allow the near field environment to be discriminated by complex reflectance measurements in that particular frequency channel. Alternatively, complex reflectance measurements obtained in different frequency channels are combined into a single feature vector. Thus, if complex reflectance is measured in N frequency channels, near field environments will be associated with decision regions in a discrimination space of dimension 2N. If the complex reflectance is augmented with other measurements the dimension of the discrimination space will be increased accordingly.

In block 306 the decision surfaces or other information about the decision regions is stored for future use. A look up table in which each memory location corresponds (by address) to a particular value of complex reflectance and each memory location stores an index identifying a near field environment associated with the particular value of complex reflectance can be used to store the decision regions. In the case that the mobile unit is capable of operating in multiple frequency bands, and the complex reflectance measurements in each frequency band are used separately to classify the near field environment of the mobile unit, a look up table in which each memory location corresponds (by address) to a particular value of frequency and complex reflectance can be used to store decision regions. Alternatively, separate look up tables can be used for each frequency band. In the case that the complex reflectance measurements at a set of frequencies are combined into a single feature vector, a look up table in which each memory location corresponds (by address) to a particular set of values of the complex reflectance's at the set of frequencies and each memory location stores an index identifying a near field environment associated with the set of values of the complex reflectance's can be used to store decision regions. Block 302 is executed using one or more mobile units (e.g., the first mobile unit 118) that are capable of measuring the complex reflectance from their antennas (e.g., 202). The data obtained in block 302 is suitably transferred to a machine with greater computing power (e.g., a desktop computer) and block 304 is suitably executed on the machine with greater computing power. The decision surfaces determined in block 304 will be initially stored in the machine (e.g., desktop computer) used to execute block 304. Subsequently, data defining the decision surfaces is loaded into many mobile units of the type used in block 302 to collect the training data, so that these mobile units can be used in a wireless communication system (e.g., 100). When used in a wireless communication system (e.g., 100) the mobile units having the data defining decision surfaces and corresponding pattern recognition software that uses the decision surfaces will be capable of discriminating their near field environment and sending identification of their near field environment to a data collection site (e.g., diagnostic data logger 122). The pattern recognition software may be relatively simple. For example in the case in which decision region information is stored in one or more look up tables, the pattern recognition software simply looks up near field environment identifying indexes in the look up table. Other types of pattern recognition software e.g., Bayesian may need to evaluate mathematical functions, e.g., probabilities that a particular feature vector indicates a particular near field environment. The data identifying the near field environment, optionally compounded with other data (e.g., RSSI (Receive Signal Strength Indication), mobile unit location) will assist engineers in better understanding the performance of the wireless communication system (e.g., 100) and the mobile units (e.g., 118). The data identifying the near field environment can also be used to trigger an alert to the user of the mobile unit to change the near field environment of the mobile unit in order to obtain better QoS.

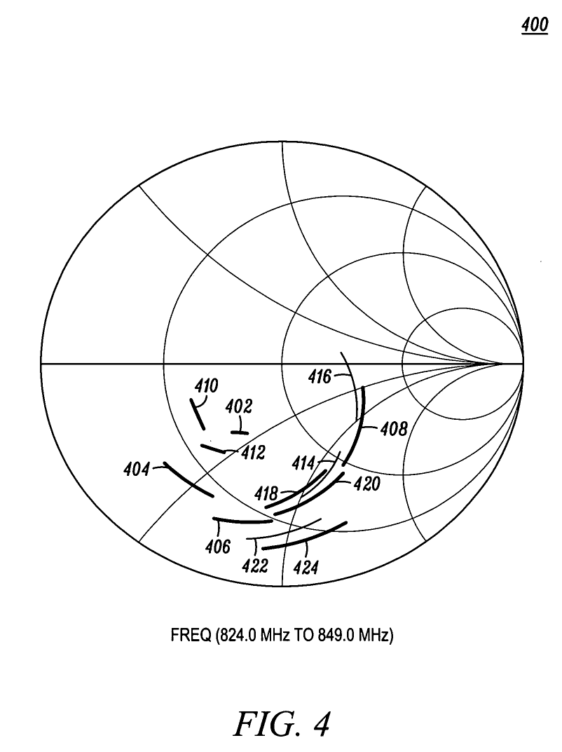

FIG. 4 is a first Smith chart 400 showing complex reflectance data for twelve near field environments of a particular model of mobile unit. For each near field environment an arc is shown on the Smith chart 400. Each arc characterizes a particular near field environment. Frequency varies along each arc within the Cellular Frequency Band, increasing in the counter clockwise direction from a low frequency of 824.0 MHz to a high frequency of 849.0 MHz. The measurements were made using one exemplary V600 mobile telephone manufactured by Motorola of Schaumburg, Ill. V600 that was modified to include components shown in FIG. 2. Table I indicates the near field environment that each arc represents.

| Ref. No. | Near Field Environment |
|---|---|
| 402 | Talking Position-Finger on Tip |
| 404 | Talking Position-Finger on Length |
| 406 | Talking Position-Finger on Base |
| 408 | Talking Position-Finger Not Touching |
| 410 | Dialing Position-Finger on Tip |
| 412 | Dialing Position-Finger on Length |
| 414 | Dialing Position-Finger on Base |
| 416 | Dialing Position-Finger Not Touching |
| 418 | Telephone on Plastic-Flip Open |
| 420 | Telephone on Plastic-Flip Closed |
| 422 | Telephone on Metal-Flip Open |
| 424 | Telephone on Metal-Flip Closed |

When the measurements used to collect the data shown in FIG. 4 are repeated numerous times, using different mobile units of the same type a statistical distribution of measurements is obtained for each near field environment, for each frequency. Such statistically distributed data is the training data that is to be used by the pattern recognition training algorithms. The near field environments represented in FIG. 4 are merely exemplary. For each model of mobile unit a determination as to what near field environments the mobile unit should be trained to distinguish is suitably made based on how users typically hold the particular model of mobile unit and which near field environments can be discriminated based on the feature vector (e.g., complex reflectance at a single frequency or complex reflectance at multiple frequencies, augmented or not augmented with other measurements) that is used.

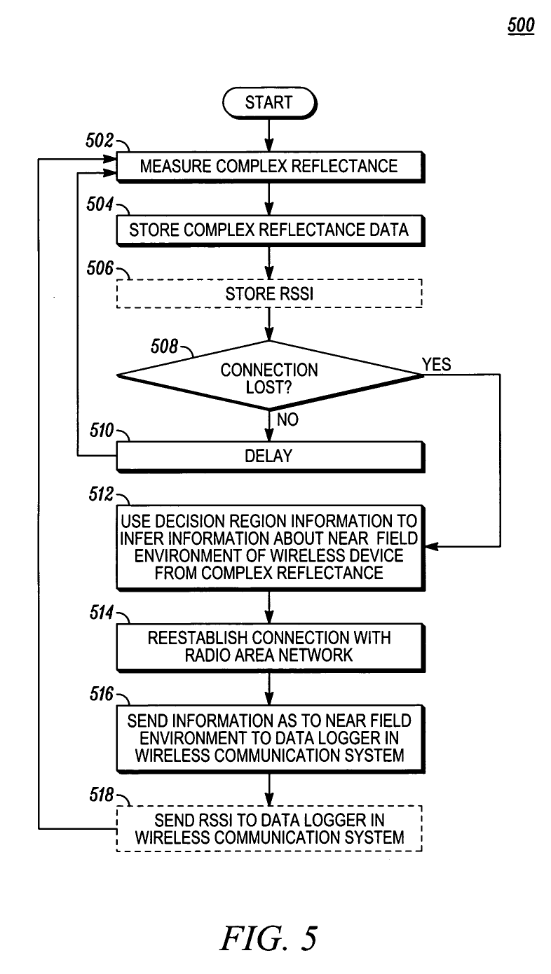

FIG. 5 is a flowchart 500 of a method of collecting and transmitting data about near field environments of a mobile unit (e.g., 118). In block 502 the complex reflectance within the mobile unit (e.g., 118) from the antenna (e.g. 202) of the mobile unit is measured. In block 504 the complex reflectance is stored in a memory (e.g., 236) of the mobile unit. In optional block 506 the RSSI is stored in the memory of the mobile unit. The RSSI is suitably measured in the transceiver (e.g. 210) of the mobile unit. Block 508 is a decision block that determines if a wireless connection to the mobile unit has been lost. (For example in the case of a cellular telephone mobile unit, block 508 suitably determines if a call drop has occurred). When the wireless connection has not been lost, then the flowchart 400 suitably loops back to block 502 after a delay 510. As shown, the complex reflectance will be measured periodically while the wireless connection is maintained. A predetermined number of most recent complex reflectance measurements taken a periodically can be kept in memory. By way of nonlimitive example, 64 to 256 samples taken at a rate of from 4 to 16 samples per second may be maintained in memory. The rate is based on the speed at which users typically manipulate their mobile units. The rate is meant to be high enough, in light of the speed at which users typically manipulate their mobile units, so that, typically, the near field environment will not change substantially between measurements. The number of samples maintained in memory is meant to span a duration that is at least as long as the interval between a change in the near field environment that causes loss of a wireless connection and the moment at which the loss of the wireless connection is recognized.

When it is determined in block 508 that the wireless connection was lost, then the flowchart 500 branches to block 512. In block 512 information that defines decision regions corresponding to a plurality of classes of near field environments is used by a pattern recognition algorithm (e.g., Bayesian, linear or nearest neighbor) to identify the near field environment of the mobile unit. In the case that several recent complex reflectance values are kept in the memory in the mobile unit, block 512 is suitably executed for each complex reflectance value separately, or alternatively for one or more averages or filtered values derived from the several recent complex reflectance values.

In block 514 a connection between the mobile unit and the wireless communication system in which the mobile unit is operating is reestablished. For the purpose of the method shown in FIG. 5, the connection that is established in block 514 need not be a user application (e.g., voice telephony) connection, as it is only needed for transferring network diagnostic data. In block 516 information as to the near field environment of the mobile unit that was determined in block 512 is sent to a data logger (e.g., 122) in the wireless communication system. In optional block 518 the RSSI is sent to the data logger in the wireless communication system. Thereafter, the flowchart 500 returns to block 502 and continues executing as described above. A program that executes the method 500 shown in FIG. 5 is suitably stored in the program memory 240 and executed by the processor 238. The method 500 can also be executed by hardware that differs in design from that shown in FIG. 2.

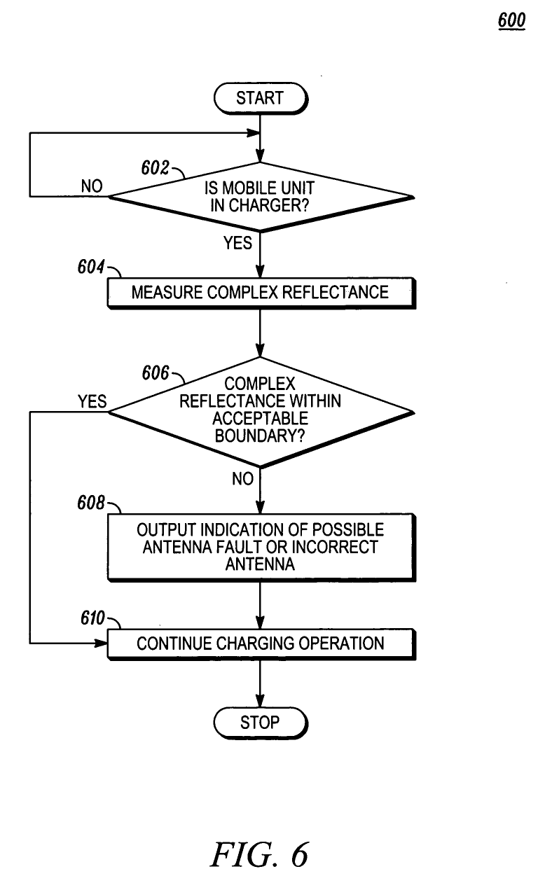

FIG. 6 is a flowchart 600 of a method of detecting an incorrect type antenna or an antenna fault condition in a mobile unit (e.g. 118). The method shown in FIG. 6 uses the complex reflectance from the antenna (within the mobile unit) to discriminate faulty or incorrect type antennas from correct type, normally functioning antennas. The method shown in FIG. 6 is especially suitable for two-way radios used by police and fire departments. Such two-way radios are often subjected to rough handling and have extending antennas which are prone to damage. Furthermore, such two-way radios often use standard antenna connectors that allow wrong type antennas (e.g. antennas intended for a different frequency band) to be erroneously connected.

Referring to FIG. 6, block 602 is a decision block that determines if the mobile unit is in a charger. Testing for antenna fault conditions and for antennas of incorrect type is suitably performed when the mobile unit is in the charger, because the charger provides a controlled repeatable environment for testing. Typically, the charger locates the mobile unit away from conductive or other objects that impact the near field of the antenna and could cause misleading test results. When the mobile unit is in the charger, the flowchart proceeds to block 604 in which the complex reflectance is measured. In block 604 the complex reflectance can be measured in one frequency channel or in multiple frequency channels that the mobile unit executing method uses. Block 606 is decision block that depends on whether the complex reflectance is within acceptable bounds, i.e. within a decision region for normal working antennas of the correct type. If, in block 604, the complex reflectance is measured in multiple frequency channels then the outcome of block 606 suitably depends on whether the complex reflectance is within acceptable bounds established for each frequency channel. When the complex reflectance is within acceptable bounds then a charging operation is continued. When the outcome of block 606 is negative, then in block 608 an indication of the antenna fault or incorrect type antenna is output (e.g., through the user interface, 234). The indication could take the form of visual indication (e.g., a displayed message, flashing indicator light) or and audio indication (e.g. an audible beep). For executing the method shown in FIG. 6, data defining the decision boundary between correct type, properly functioning antennas and incorrect type or faulty antennas is loaded into the program memory 240 of the first mobile unit 118 along with a pattern recognition program that uses the decision boundary to discriminate between faulty or incorrect type antennas and correct type normally functioning antennas. A program that executes the method 600 shown in FIG. 6 is suitably stored in the program memory 240 and executed by the processor 238. The method 600 can also be executed by hardware that differs in design from that shown in FIG. 2.

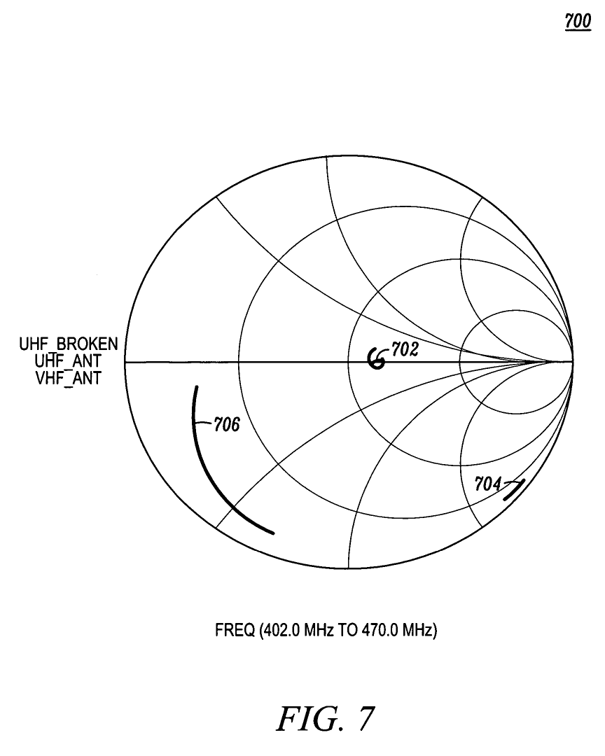

FIG. 7 is a second Smith chart 700 showing complex reflectance measured in a UHF two-way radio with a correct UHF antenna, with a broken UHF antenna, and with an incorrect VHF antenna. A first contour 702 in the second Smith chart 700 is for the correct UHF antenna, a second contour 704 is for a broken UHF antenna and a third contour 706 is for the incorrect VHF antenna. Frequency varies along the contours 702, 704, 706 from 402 MHz to 470 MHz. When training data for use in the method shown in FIG. 6 is collected, statistical distributions of measurement values will be obtained for each frequency, for the correct, a plurality of incorrect antennas and a plurality of broken antennas. Alternatively, training data is only collected for properly working antennas of the correct type and a decision boundary is determined based on this training data.

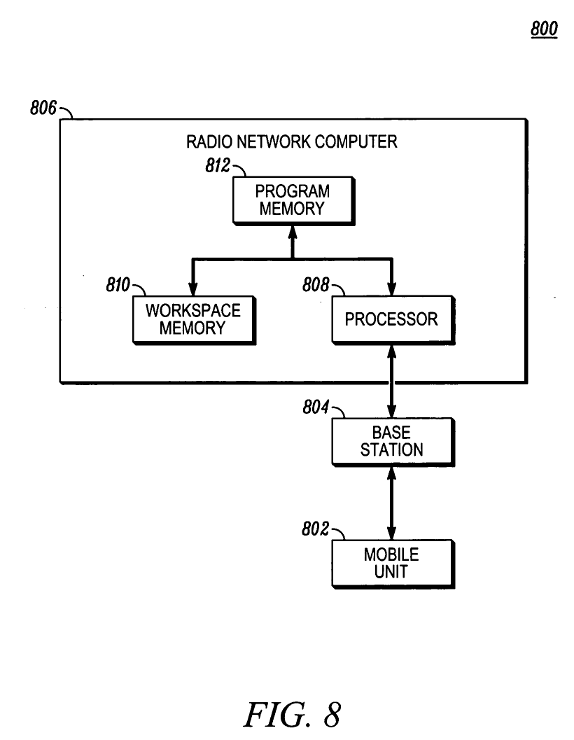

FIG. 8 is block diagram of a wireless communication system 800 in accordance with some embodiments of the invention. The wireless communication system 800 comprises a third mobile unit 802, a fourth base station 804 and a radio network computer 806. The third mobile unit 802 can have the same architecture as shown for the first mobile unit in FIG. 2 or a different architecture. However, the third mobile unit does not need to be loaded with data defining decision boundaries or a pattern recognition program. The third mobile unit 802 is adapted to measure complex reflectance from its antenna (e.g., 202) and transmit the complex reflectance data through the fourth base station 804 to the radio network computer 806. The radio network computer 806 has a processor 808, a workspace memory 810 (e.g., RAM) and a program memory 812. The radio network computer serves as a classification device for classifying the near field environment of the third mobile unit 802. The program memory 812 is used to store decision region information for a complex reflectance based discrimination space and a pattern recognition program that uses the decision region information. The defined decision regions correspond to different near field environments of the mobile unit 802. Alternatively, the decision regions correspond to normal and incorrect type or faulty antenna conditions. In the wireless communication system 800, complex reflectance values are received by the radio network computer 802 and are used by the pattern recognition program stored in the program memory 812 to determine the near field environment of the mobile unit 802 or to assess the antenna (e.g., 202) of the mobile unit 802.

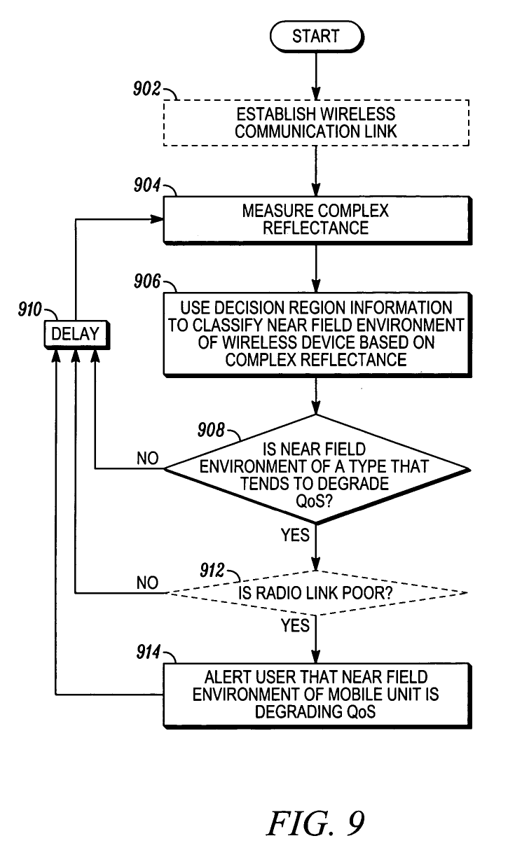

FIG. 9 is a flowchart of a method 900 of alerting a mobile unit user that the near field environment of the mobile unit is adversely affecting performance of the mobile unit. In optional block 900, a mobile unit (e.g., the first mobile unit 118) is operated to establish a wireless connection. Alternatively, the method 900 is performed without establishing a wireless connection. In block 904 the complex reflectance within the mobile unit from an antenna (e.g., antenna 202) of the mobile unit is measured. In block 906, previously stored decision region information is used to classify the near field environment of the mobile unit. Block 908 is a decision block, the outcome of which depends on whether the near field environment of the mobile unit is one that tends to degrade QoS. When it is determined in decision block 908 that the near field environment of the mobile unit is not one that tends to degrade QoS, then after a delay 910 the method 900 loops back to block 904 to measure the complex reflectance again and proceeds as previously described. For the purpose of the method 900, the space of phase difference and magnitude difference can be divided into only two decision regions-one in which QoS tends to be degraded and one in which QoS tends not to be degraded. Alternatively, more than two decision regions are used and each is labeled as either tending to degrade QoS or not tending to degrade QoS.

When, on the other hand, it is determined in block 908 that the near field environment of the mobile unit is one that tends to degrade the QoS, then the method 900 continues with optional block 912. When optional block 912 is not used then the method 900 continues with block 914. Optional decision block 912 depends on whether one or more measures of radio link quality indicate poor radio link quality. The one or more measures of radio link quality suitably comprise, by way of nonlimitive example, RSSI, and/or channel decoder error rate. When it is determined in optional block 912 that the radio link quality is not poor then, after the delay 910, the method 900 loops back to block 904 to measure the complex reflectance again and proceeds as previously described. An example of a circumstance in which the radio link quality is sufficient to obtain a negative outcome of block 912 notwithstanding a near field environment that tends to degrade QoS is the case that the mobile unit performing the method 900 is located very close to another unit (e.g., base station transceiver) with which the mobile unit performing the method 900 is communicating. When it is determined in block 912 that the radio link quality is poor then the method proceeds to block 914. When block 912 is used then, alternatively, block 912 can be placed ahead of block 904 and execution of block 904 and the subsequent blocks can be conditioned on a positive outcome of block 912.

In block 914 a user interface (e.g., 234, 1200) is used to alert the user of the mobile unit performing the method 900 that the near field environment of the mobile unit performing the method 900 tends to degrade the QoS. By way of nonlimiting example, an alert issued in block 914 suitably takes the form of an audible alert (e.g., a beep, or MIDI or other jingle), a displayed message or icon, other visible alert (e.g., LED or other light source) and/or a tactile alert. The alert generated in block 914 will prompt the user of the mobile unit to change the near field environment (e.g., change the manner of grasping the mobile unit, if the mobile unit is being held, or change the location of the mobile unit if the mobile unit is placed on an object) in order to improve the QoS. Users can be informed as to the meaning of the alert by instruction materials provided with the mobile unit. The type of alert generated in block 914 may be varied depending on the state of the mobile unit. For example, in the case of cellular telephone that is capable of a speakerphone mode, a visual alert could be used in speakerphone mode and a short tactile pulse could be used in normal speaking mode. A program that executes the method 900 shown in FIG. 9 is suitably stored in the program memory 240 and executed by the processor 238. The method 900 can also be executed by hardware that differs in design from that shown in FIG. 2.

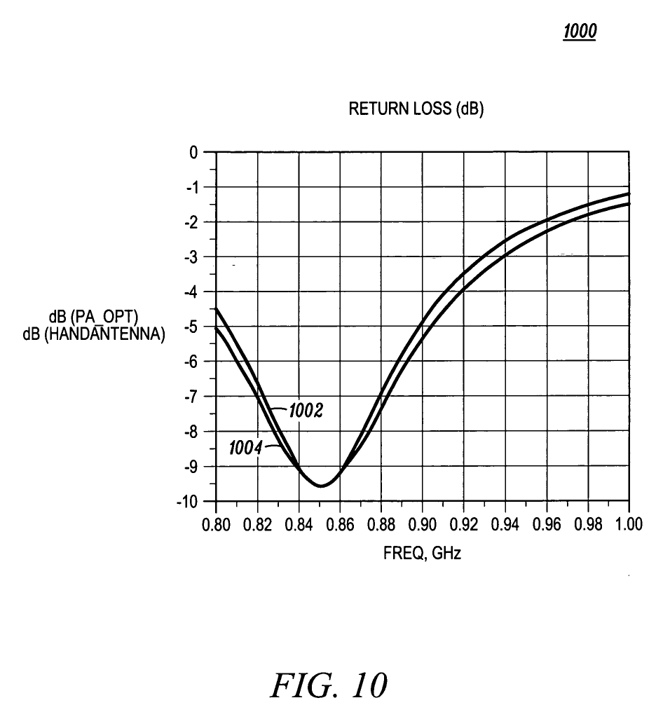

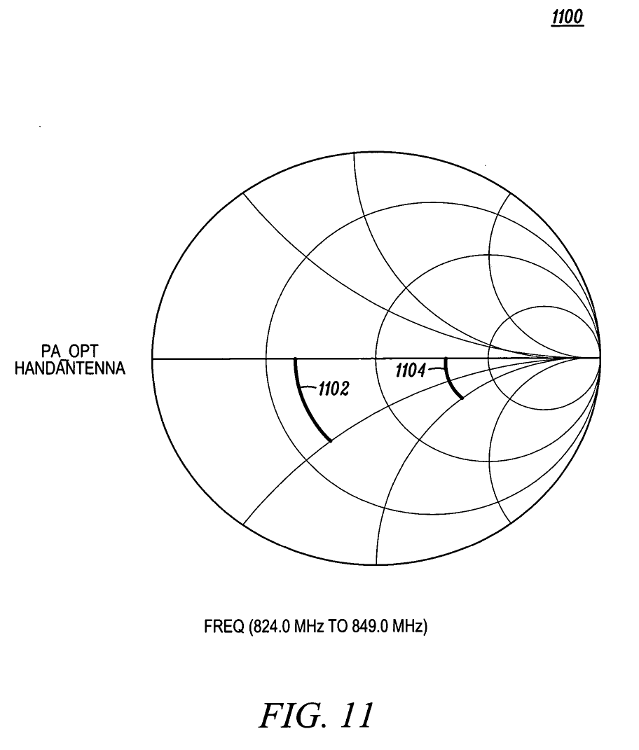

The decision made in decision block 908 is based on information, programmed into the mobile unit, as to whether the near field environment of the mobile unit degrades the QoS. Note that the magnitude of the complex reflectance alone is not, in general, sufficient to discriminate near field environments that degrade the QoS. For example, in certain near field environments in which the magnitude of the complex reflectance is relatively low, a large portion of signal power is absorbed by objects in the near field environment. Moreover, certain phase regions of the complex reflectance are associated with diminished performance of power amplifiers (e.g., 208). Thus, the magnitude of reflectance, by itself, would sometimes fail to reveal near field environments that degrade performance. This point is illustrated by FIGS. 10 and 11. FIG. 10 is a graph 1000 including plots of return loss vs. frequency for two near field environments of a mobile unit (e.g., 118). A first plot 1002 shows return loss for a first near field environment in which nothing is touching the antenna and the performance of the power amplifier is not compromised by a disadvantageous phase of the complex reflectance. A second plot 1004 shows the return loss for a second near field environment in which a user's hand is touching the antenna leading to poor power amplifier performance. As shown in the graph 1000 the two return loss plots 1002 1004 are barely distinguishable. FIG. 11 is smith chart 1100 showing complex reflectance for a range of frequency for the two near field environments. A first contour 1102 shows the complex reflectance for the first near field environment (corresponding to plot 1002 in FIG. 10) and a second contour 1104 shows the complex reflectance for the second near field environment (corresponding to plot 1104 in FIG. 10). Thus, by using the complex reflectance as a discriminant for near field environments, near field environments that produce similar return loss (and VSWR) but are relatively different in regard to their effect on mobile unit performance can be effectively discriminated.

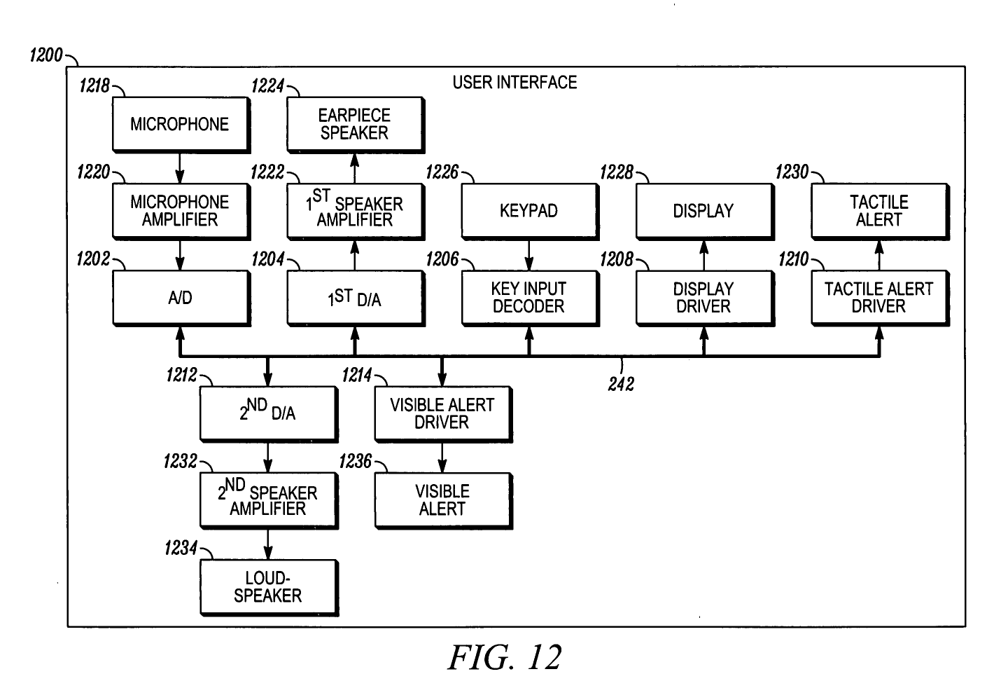

FIG. 12 is a block diagram of a user interface 1200 of a cellular telephone type mobile unit. As shown in FIG. 12, an analog-to-digital converter (A/D) 1202, a first digital-to-analog converter (D/A) 1204, a key input decoder 1206, a display driver 1208, a tactile alert driver 1210, a second D/A 1212, and a visible alert driver 1214 are coupled to the signal bus 242. A microphone 1218 for inputting a user's speech and other sounds is coupled through a microphone amplifier 1220 to the A/D 1202. The first D/A 1204 is coupled through a first speaker amplifier 1222 to an earpiece speaker 1224. A keypad 1226 for entering commands and telephone numbers is coupled to the key input decoder 1206. A display 1228 which is useable for displaying visual alert messages generated in block 914 of the method 900 shown in FIG. 9 is coupled to the display driver 1208. A tactile alert 1230 which is useable for generating tactile alerts generated in block 914 is coupled to the tactile alert driver 1210. The second D/A 1212 is coupled through a second speaker amplifier 1232 to a loudspeaker 1234. The earpiece speaker 1224 and the loudspeaker 1234 are useable for outputting the alert generated in block 914. A visible alert 1236 is coupled to the visible alert driver 1214. By way of nonlimitive example the visible alert can comprise a LED, and/or an electroluminescent device. The visible alert 1236 can comprise a backlight of the display 1228. For outputting the alert generated in block 914 the visible alert 1236 can be flashed on or if the alert is on, flashed off.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The inventionis defined solely by the appended claims including any amendments made during the pendency of this application and all equivalents of those claims as issued.

What is claimed is:

1. A mobile wireless communication device comprising:
a transceiver comprising a power amplifier;
a directional coupler comprising a first input port coupled to said power amplifier, an input/output port, a first measurement port and a second measurement port;
an antenna coupled to said input/output port;
a phase and magnitude difference measurement circuit coupled to said first measurement port and to said second measurement port, wherein said phase and magnitude difference measurement circuit measures a phase difference between a phase of a first signal propagated from said power amplifier toward said antenna and a phase of a second signal reflected by said antenna, and measures a magnitude difference between a magnitude of said first signal and a magnitude of said second signal; and
a classification circuit coupled to said phase and magnitude difference measurement circuit, wherein said classification circuit is adapted to determine a classification of a near field environment of said mobile wireless communication device based on said phase difference and said magnitude difference.

2. The mobile wireless communication device according to claim 1 wherein said classification circuit comprises:
one or more memories for storing a pattern recognition program and information defining a plurality of decision regions; and
a processor coupled to said one or more memories, wherein said processor is programmed by said pattern recognition program to determine which of said plurality of decision regions includes said phase difference and said magnitude difference.

3. A method of collecting wireless network diagnostic data comprising:
taking a measurement of a near field environment of a wireless communication device in said wireless network from within said wireless communication device; and
sending a diagnostic datum based on said measurement through said wireless network to a data logger.

4. The method of collecting wireless network diagnostic data according to claim 3 wherein taking said measurement of said near field environment comprises:
measuring a phase difference between a first signal propagating from a power amplifier of said wireless communication device toward an antenna of said wireless communication device and a second signal reflected from said antenna of said wireless communication device toward said power amplifier of said wireless communication device; and
measuring a magnitude difference between a magnitude of said first signal and a magnitude of said second signal.

5. The method of collecting wireless network diagnostic data according to claim 4 further comprising:
determining a classification of the near field environment of the wireless communication device by identifying a decision region that includes said phase difference and said magnitude difference; and
wherein said diagnostic datum includes said classification.

6. The method of collecting wireless network diagnostic data according to claim 3 further comprising:
storing said measurement in said wireless communication device; and
wherein, sending said diagnostic datum is performed in response to loosing a wireless communication connection with said wireless communication device after said wireless communication connection has been restored.

7. A mobile wireless communication device comprising:
a transceiver comprising a power amplifier;
a directional coupler comprising a first input port coupled to said power amplifier, an input/output port, a first measurement port and a second measurement port;
an antenna coupled to said input/output port;
a phase and magnitude difference measurement circuit coupled to said first measurement port and to said second measurement port, wherein said phase and magnitude difference measurement circuit measures a phase difference between a phase of a first signal propagated from said power amplifier toward said antenna and a phase of a second signal reflected by said antenna, and measures a magnitude difference between a magnitude of said first signal and a magnitude of said second signal; and
an antenna fault detection circuit coupled to said phase and magnitude difference measurement circuit, wherein said antenna fault detection circuit is adapted to detect a fault condition of said antenna based on said phase difference and said magnitude difference.

8. The mobile wireless communication device according to claim 7 wherein said fault detection circuit comprises:
one or more memories for storing a fault detection program and information defining a fault condition; and
a processor coupled to said one or more memories, wherein said processor is programmed by said fault detection program to determine if an antenna fault condition exists based on said phase difference and said magnitude difference.

9. A method of detecting an antenna fault in a wireless communication device, the method comprising:
measuring a phase difference between a first signal propagating from a power amplifier of said wireless communication device toward an antenna of said wireless communication device and a second signal reflected from said antenna of said wireless communication device toward said power amplifier of said wireless communication device;
measuring a magnitude difference between a magnitude of said first signal and a magnitude of said second signal; and
determining if said phase difference and said magnitude difference are outside a decision region corresponding to acceptable antenna performance.

10. A wireless communication diagnostic system comprising:
a mobile wireless communication device comprising:
a transceiver comprising a power amplifier;
a directional coupler comprising a first input port coupled to said power amplifier, an input/output port, a first measurement port and a second measurement port;
an antenna coupled to said input/output port;
a phase and magnitude difference measurement circuit coupled to said first measurement port and to said second measurement port, whereby said phase and magnitude difference measurement circuit measures a phase difference between a phase of a first signal propagated from said power amplifier toward said antenna and a phase of a second signal reflected by said antenna, and measures a magnitude difference between a magnitude of said first signal and a magnitude of said second signal;
a memory for storing said phase difference and said magnitude difference; and
a classification device communicatively coupled to said mobile wireless communication device wherein said classification device is adapted to receive said phase difference and said magnitude difference, and to determine a classification of a near field environment of said mobile wireless communication device based on said phase difference and said magnitude difference.

11. The wireless communication diagnostic system according to claim 10 wherein said classification device comprises:
one or more memories for storing a pattern recognition program and information defining a plurality of decision regions; and
a processor coupled to said one or more memories, wherein said processor is programmed by said pattern recognition program to determine which of said plurality of decision regions includes said phase difference and said magnitude difference.

12. A mobile wireless communication device comprising:
an alert;
a transceiver comprising a power amplifier;
a directional coupler comprising a first input port coupled to said power amplifier, an input/output port, a first measurement port and a second measurement port;
an antenna coupled to said input/output port;
a phase and magnitude difference measurement circuit coupled to said first measurement port and to said second measurement port, whereby said phase and magnitude difference measurement circuit measures a phase difference between a phase of a first signal propagated from said power amplifier toward said antenna and a phase of a second signal reflected by said antenna, and measures a magnitude difference between a magnitude of said first signal and a magnitude of said second signal; and
a circuit coupled to said phase and magnitude difference measurement circuit and to said alert wherein said circuit is adapted to determine if a near field environment of said mobile wireless communication device tends to degrade communications with said wireless communication device based on said phase difference and said magnitude difference and in said near field environment tends to degrade communications activate said alert.

13. The mobile wireless communication device according to claim 12 wherein said circuit comprises:
one or more memories for storing a pattern recognition program and information defining one or more decision regions defined in a space of phase difference and magnitude difference, wherein said one or more decision regions are associated with one or more near field environments that tend to degrade communications with said wireless communication device; and
a processor coupled to said one or more memories, wherein said processor is programmed by said pattern recognition program to determine if said one or more decision regions includes said phase difference between said first signal and said second signal and said magnitude difference between said first signal and said second signal.

14. A method of operating a wireless communication device comprising:
measuring a phase difference between a first signal propagating from a power amplifier of said wireless communication device toward an antenna of said wireless communication device and a second signal reflected from said antenna of said wireless communication device toward said power amplifier of said wireless communication device;
measuring a magnitude difference between a magnitude of said first signal and a magnitude of said second signal; and
determining if said phase difference and said magnitude difference are inside one or more decision region corresponding to one or more near field environments that tend to degrade operation of the wireless communication device, and if so;
alerting a user of said wireless communication device.

15. The method according to claim 14 wherein
alerting the user comprise activating an alert selected from the group consisting of an audible alert, a visible alert and a tactile alert.
